(19) United States
(12) Patent Application Publication
(10) Pub. No.: US 2014/0278774 A1
(43) Pub. Date: Sep. 18, 2014

(54) IN THE MARKET MODEL SYSTEMS AND METHODS

(71) Applicant: Experian Information Solutions, Inc., Costa Mesa, CA (US)

(72) Inventors: Xiaohua Cai, Irvine, CA (US); Piew Datta, Carlsbad, CA (US); Charles Robida, Roswell, GA (US)

(21) Appl. No.: 14/198,286

(22) Filed: Mar. 5, 2014

Related U.S. Application Data
(60) Provisional application No. 61/779,328, filed on Mar. 13, 2013.

(51) Int. Cl. G06Q 30/02

(52) U.S. Cl. CPC G06Q 30/0202
USPC 705/7.31

(57) ABSTRACT

One embodiment includes a system and method for identifying potential consumer candidates in the market for products or services is disclosed. The system and method may predict whether a consumer is likely to be “in the market” for a product or service can be achieved by utilizing an “in the market” system to determine which groups of consumers will likely respond to solicitation or be in need of a product or service. The system and method may provide data that allows businesses to quickly determine consumer groups that will likely utilize their services or purchase their products.

### CROSS-REFERENCE TO RELATED APPLICATIONS

This application claims priority benefit under 35 U.S.C. §119(e) of U.S. Provisional Application No. 61/779,328, filed on Mar. 13, 2013, which is hereby incorporated by reference herein in its entirety.

### BACKGROUND

Businesses are constantly searching for new customers and different ways to expand their customer base. One of the best of ways of accomplishing this goal is through effective marketing strategies. Marketing campaigns to efficiently target potential customers can be expensive for most businesses. Without careful research and analysis of the relevant consumer base, businesses can often waste valuable time and money on misguided marketing efforts.

### BRIEF DESCRIPTION OF THE DRAWINGS

FIG. 1 is a block diagram showing one embodiment of an in the market system.

FIG. 2 is a flow chart illustrating one embodiment of a method of applying an in the market model an estimated score stability system.

FIG. 3 is a flow chart illustrating one embodiment of a method of creating to create an in the market model.

FIG. 4A illustrates an embodiment of a flowchart illustrating a method of segmentation by applying an in the market model

FIG. 4B illustrates an example implementation of the embodiment described in FIG. 4A, illustrating a method of applying an in the market model.

### SUMMARY OF CERTAIN EMBODIMENTS

One embodiment described herein includes a system for predicting whether a consumer is likely to be in the market for a product or service, the system comprising: a first physical data store configured to store credit data; a computing device in communication with the first physical data store and configured to: receive a request for an in the market assessment associated with at least one consumer; access credit data from the first physical data store associated with at least one consumer; apply in the market model to accessed credit data wherein the in the market model uses at least one trended attribute to assign at least one consumer to a trended attribute segment and applies a predictive sub-model to the corresponding trended attribute segment; and generate an in the market score representative of a likelihood the at least one consumer is in the market for a product or service.

An additional embodiment discloses a computer-implemented method of predicting whether a consumer is in the market for a product or service, the method comprising: receiving a request for an in the market assessment associated with a first consumer; accessing, from an electronic data store, credit data associated with the first consumer; processing, with one or more hardware computer processors, a in the market model to segment the first consumer into one of a plurality of trended attribute segments, wherein the in the market model analyzes the accessed credit data to assign at least one consumer to a trended attribute segment and applies a predictive sub-model to the corresponding trended attribute segment to generate an in the market score representative of the likelihood the first consumer is in the market for a product or service; and outputting the in the market score.

Another embodiment discloses a non-transitory computer storage having stored thereon a computer program that instructs a computer system by at least: receiving a request for an in the market assessment associated with a first consumer; accessing, from an electronic data store, credit data associated with the first consumer; processing, with one or more hardware computer processors, a in the market model to segment the first consumer into one of a plurality of trended attribute segments, wherein the in the market model analyzes the accessed credit data to assign at least one consumer to a trended attribute segment and applies a predictive sub-model to the corresponding trended attribute segment to generate an in the market score representative of the likelihood the first consumer is in the market for a product or service; and outputting the in the market score.

Another embodiment discloses a method of assessing whether a consumer is in the market for a good or service, the method comprising: processing, with one or more hardware computer processors, credit data associated with a first consumer for whom a request for an in the market assessment has been received; based at least partly on said processing, executing an in the market model and assigning the first consumer to a first trended attribute segment of a plurality of trended attribute segments, and executing a predictive sub-model to the corresponding first trended attribute segment; and generating, an in the market score representative of the likelihood the first consumer is in the market for a product or service.

### DETAILED DESCRIPTION OF CERTAIN EMBODIMENTS

As a result of the prevalent concern of saving time and money directed toward marketing efforts, there is now a need for businesses to be able to quickly categorize consumer groups and determine which groups will likely respond to marketing efforts. This can be achieved by utilizing an “in the market” system to determine which groups of consumers will likely respond to solicitation or be in need of a product or service. The system may provide data that allows businesses to quickly determine consumer groups that will likely utilize their services or purchase their products. Additionally, the system may provide the businesses with a score that represents the likelihood that a particular consumer will respond to solicitation or need to utilize a service or purchase a product. The in the market system can efficiently target consumers and therefore expand a business's customer base. As a result, businesses utilizing the in the market model can increase profitability.

Discussed herein are example systems and methods for identifying potential consumer candidates in the market for products or services. The in the market model segments consumers into one of several segments by applying trended credit data or finance attributes to trended data associated with a consumer. A model or sub-model specific to each particular segment is then applied to each of the corresponding segments. The in the market model system then returns an in the market score or other determinative information which indicates whether the particular consumer is likely to be in the market for a product or service within a certain time period.

In one embodiment, the in the market system analyzes a credit data to determine and define trended attribute segments. This analysis can be based on either a combination of the current and historical credit data or only historical credit data. For example, the in the market model can access a data store to retrieve historical data for a set of consumers over a period of six months. This information may include the consumers' balances, limits, and payment status for each of the consumer's trades. Using this information, the in the market system can determine the consumers' credit limit, status of accounts (for example delinquent, open, or closed), as well as the consumers' revolving credit to debt ratio over the period of six months. This information can be analyzed along or in combination with the consumers' current credit information to allow the system to determine or predict whether a consumer would likely meet a particular trended attribute and fall within a trended attribute segment. For example, the credit data may be analyzed to determine factors that predict whether a consumer is likely a balance transferor who transfers balances from one card to another, whether the consumer is likely a revolver (for example, a consumer that has less than a 50% pay down of the balance), whether the consumer is likely a transactor (for example, a consumer that has a 50% or greater pay down of the balance), and/or whether the consumer is likely a rate surfer (for example, a consumer that transfers balances or changes card uses based on lower interest rates or other charges).

Once the trended attribute segments have been assigned, a set of consumers to be used in developing a model may be segmented into the trended attribute segments using their corresponding credit data. Once the consumers have been assigned to a segment, a sub-model for predicting whether those consumers are in the market for a particular product or service may be generated and stored. Separate sub-models are generated for each trended attribute segment.

After the model is generated, the system may analyze the credit data of a consumer to determine whether that consumer is in the market for a particular product or service. The system applies the trended attributes on the consumer's credit data to assign the consumer to one of the trended attribute segments. Then, the sub-model created for that particular segment is applied to the consumer's credit data. The sub-model generates an in the market score which allows the requesting entity to determine the likelihood that the consumer will respond to solicitation for a product or service or is “in the market” for a new product or service.

The in the market model can also be integrated with a targeting tool that recommends and/or generates incentives or feature recommendations for consumers assigned to particular trended attribute segments. For example, if a consumer falls in the rate surfer segment and receives a score indicating that the consumer is in the market for a new bank card, the targeting tool may suggest offering that consumer a product with a low interest rate but a higher annual fee knowing that the consumer is likely focusing on the interest rate. Entities can utilize this information to further tailor their marketing efforts thereby increasing the likelihood a consumer will respond to solicitations for products or services. In some embodiments, the incentives and or recommendation information may be provided after the sub-model of the in the market model is applied to consumers in the trended attribute segment and a score is generated.

As used herein, the terms “individual” and/or “consumer” may be used interchangeably, and should be interpreted to include applicants, customers, single individuals as well as groups of individuals, such as, for example, families, married couples or domestic partners, business entities, organizations, and other entities.

More particularly, the terms “individual” and/or “consumer” may refer to: an individual subject of the in the market system (for example, an individual person whose credit data is being complied and an in the market score is being calculated). The terms “customer,” “business,” and/or “client” may refer to a receiver or purchaser of the in the market score information that is produced by the in the market system (for example, a lender that is receiving a credit profile report on an individual, including an in the market score for the individual).

In general, however, for the sake of clarity, the present disclosure usually uses the term “consumer” to refer to an individual subject of the in the market system, and the term “client” to refer to a receiver or purchaser of the in the market score information that is produced by the in the market score system.

### In the Market System

FIG. 1 illustrates one embodiment of a configuration of an in the market system 130 in communication with a credit data sources 124, historical credit data sources 125, and a requesting entity 127. In one embodiment, the in the market system 130 is maintained by a credit bureau. In one embodiment, the credit data sources 124 and historical credit data sources 125 are also maintained by a credit bureau, such that links between the in the market system 130 and the data sources are via a direct link, such as a secured local area network, for example. In other embodiments, the configuration of an in the market system 130 may include additional or fewer components than are illustrated in the example of FIG. 1.

In the embodiment of FIG. 1, the in the market system 130 includes an in the market module 150 that is configured for execution on the in the market system 130 and is configured to access current and historical credit data for a set of consumers, to apply trended attributes to the access credit data to segment the consumers, to identify credit data factors specific to each segment which predict whether a consumer in that particular segment will likely be in the market for a product or service in a given time period, to provide weights for each of the identified credit data factors, and to store the weighed credit data factors as a model in the in the market system 130. The model is configured to generate an in the market score representing the likelihood that the consumer is in the market for a product or service and whether that consumer will respond to solicitation for that product or service. The in the market module 150 is further configured to access the stored model, to access credit data for a consumer, and to apply the model to generate a score indicating the likelihood that the consumer is in the market for a product or service. In applying the model, the consumer is assigned to a trended attribute segment and a sub-model tailored to that segment is applied to generate the consumer's score.

In one embodiment, the in the market module 150 accesses credit data by extracting portions of a consumer's current and/or historical credit data and stores the data on a local storage device, for example, the mass storage device 140.

### In The Market Scoring Method

FIG. 2 illustrates an embodiment of a flow chart showing one method (for example, a computer implemented method) of applying an in the market model to generate scores to predict the likelihood of a consumer being in the market for a product or service. The method can be performed online, in real-time, batch, periodically, and/or on a delayed basis for individual records or a plurality of records. The method may be stored as a process accessible by the in the market module 150 and/or other components of the in the market system 130. In some embodiments, the blocks described below may be removed, others may be added, and the sequence of the blocks may be altered.

With reference to FIG. 2, the method is initiated, and the in the market system 130 receives a request for in the market assessment for a set of consumers (block 200). The in the market system 130 then accesses credit data for the set of consumers (block 210). The credit data may include current credit data 124 and historical credit data 125 for one or more of the consumers. In some embodiments, the in the market system 130 may also obtain credit data from a third party system. The in the market system 130 analyzes the data by applying the in the market model (block 220) to the accessed credit data to generate one or more scores indicating the likelihood a consumer will be in the market for a product or service. In applying the in the market model, the trended attributes are applied to each consumer's credit data to assign each consumer to a segment (block 220a), and then a predictive sub-model, specific for the assigned segment, is applied (block 220b) to generate the in the market score for each consumer. The in the market system 130 then provides the in the market scores to the requesting entity (block 230). The in the market scores may be sent to a requesting entity 127, another module, another system, and/or it may be stored in the memory 180, or the like.

It is recognized that other embodiments of FIG. 2 may be used. For example, the method of FIG. 2 could store the in the market score in a database and/or apply additional rules such as, for example, removing data for consumers that do not fall within any of the segments and/or do not belong to an assigned segment. In addition, only historical credit data could be used.

In some embodiments, the in the market score data may be calculated for an individual consumer. In other embodiments, the in the market score data may be calculated for more than one consumer. For example, the in the market score data may be calculated for hundreds of consumers, thousands of consumers, tens-of-thousands of consumers, or more.

### Model Development Method

FIG. 3 illustrates one embodiment of a flow chart showing one method (for example, a computer implemented method) of analyzing credit data (for example, current credit data and historical credit data) to create one or more in the market models. The exemplary method may be stored as a process accessible by the in the market module 150 and/or other modules of the in the market system 130. In different embodiments, the blocks described below may be removed, others may be added, and the sequence of the blocks may be altered.

With reference to FIG. 3, the method is initiated, and the in the market system 130 accesses current and historical credit data for a set of consumers (block 300). In one embodiment, the current credit data and historical credit data include consumer demographic, credit, and other credit data (for example, historical balance data for a period of time, credit limits data for a period of time, or the like). Specific criteria for being categorized into a trended attribute segment may vary greatly and may be based on a variety of possible data types and different ways of weighing the data. The current credit bureau and/or historical credit data may also include archived data or a random selection of data.

The in the market model system 130 applies trended attributes to the current and historical credit data to divide the consumers into segments (block 310). For each segment, the in the market model system 130 then analyzes the current and historical credit data for consumers within the segment to identify relevant credit data to develop a sub-model tailored to that segment which indicates whether the consumer is likely to be in the market for a product or service within a time period (block 320). In one embodiment, the development of the model comprises identifying consumer characteristics, attributes, or segmentations that are statistically correlated (for example, a statistically significant correlation) with being more likely to respond to solicitation for a product or service. The development of the model may include developing a set of heuristic rules, filters, and/or electronic data screens to determine and/or identify and/or predict which consumers would be considered more likely to be in the market for a product or service based on the current and historical credit data. The model may then be stored in the in the market system 130 (block 330).

It is recognized that other embodiments of FIG. 3 may be used. For example, the method of FIG. 3 could be repeatedly performed to create multiple in the market models and/or the models may be generated using only historical credit data.

### Segmentation

FIG. 4A illustrates an embodiment of a flowchart illustrating a method of segmentation by applying an in the market model, which was created using credit data and historical credit data, to predict the likelihood of a consumer being in the market for a product or service. With reference to FIG. 4A, the method is initiated, and the in the market system 130 receives a request for in the market assessment for a set of consumers (block 400). The in the market system 130 then applies trended attributes to the consumers' historical credit data 125 to segment the consumers into groups (block 410). In some embodiments, the in the market system 130 may also use current credit data as well as other data from a third party system to segment the consumers. For each group, a sub-model specifically tailored to that group is then applied to the consumers falling within the corresponding group (block 420). In some embodiments, the sub-model applied will be different for each group or segment. The sub-model generates one or more scores for each consumer indicating the likelihood the corresponding consumer will be in the market for a product or service.

It is recognized that other embodiments of FIG. 4A may be used. For example, the flowchart of FIG. 4A could include fewer trended attribute segments or more trended attribute segments and/or some of the segments could be sub-segmented.

### Sample Trended Attribute Segments

FIG. 4B illustrates an example implementation of the embodiment described in FIG. 4A, illustrating a method of applying an in the market model, which was created using credit data and historical credit data, to predict the likelihood of a consumer being in the market for a bank card. With reference to FIG. 4B, the method is initiated, and the in the market system 130 receives a request for in the market assessment for a set of consumers to determine who will likely apply for a bank card in a predetermined time period (block 500). The in the market system 130 applies trended attributes to the consumers' historical credit data 125 to segment the consumers into groups (block 410). In this particular example, the trended attributes include the four categories of revolver, transactor, balance transferor, and rate surfer. For each group, a sub-model specifically tailored to that group is then applied to the consumers falling within the corresponding group (block 520). In this example, there is a different sub-model for revolvers, a different sub-model for transactors, a different sub-model for balance transferors, and a different sub-model for rate surfers. Each sub-model generates one or more scores indicating the likelihood a consumer will be in the market for a product or service for each of consumers in the group.

In some embodiments, the in the market system is integrated with targeting tools such that specific tools can be selected for a consumer based on the consumer's trended attribute segment and/or the consumer's score. For example, the targeting tool may automatically activate of one or more products and/or features, and/or change the product type, interest rate, and so forth. Using the example above, the data generated by the in the market system might cause or prompt a targeting tool to recommend that the consumers within the revolver trended attribute segment should be provided with products having a lower interest rate. This would encourage the consumers within this category to apply for the bank card because it would lower their payments on revolving balances.

It is recognized that a variety of trended attributed segments may be used. For example, the in the market system could predict whether a consumer was in the market for a mortgage or home loan such that the trended attributes could segment into categories such as first home/new purchase mortgage, home swap mortgage where a consumer was moving from an existing home into a new home, a refinancing mortgage, and/or an investment property mortgage where the consumer will be keeping the existing home. The trended attributes may depend on historical credit data as well as lender data, property data, and/or public records data. After segmenting the consumers in the data population into these categories, sub-models specific for each of these segments may be created by analyzing data for only those consumers that fall within each segment to predict who might be in the market for a mortgage. In addition, sub-models specific for each of these segments may be created by analyzing data for only those consumers that fall within each segment to predict who might be in the market for a home equity line of credit.

As another example, the in the market system could predict whether a consumer was in the market for an automotive loan such that the trended attributes would segment into categories such as leased vehicle and purchased vehicles. The trended attributes for this segmentation may depend on historical credit data as well as automotive data. After segmenting the consumers in the data population into these categories, sub-models specific for each of these segments may be created by analyzing data for only those consumers that fall within each segment to predict who might be in the market for an automotive loan. For example, the in the market system can identify any consumers in a development data sample who have leased a vehicle and any consumers in the development data sample who have purchased a vehicle, using historical credit data, current credit data and/or automotive data. Then, the in the market system can determine which factors predict that a consumer is likely to lease and which factors predict that a consumer is like to purchase and use those factors to create trended attributes. The in the market system can then review the consumers in the leasing segment to determine factors to develop a model that predicts whether “leasing” consumers are likely in the market for an automotive loan and also review the consumers in the purchasing segment develop a model that predicts whether the “purchase” consumers are likely in the market for a automotive loan. It is recognized that other segments may be created, such as the “purchase” segment could be broken down into “new car purchase” and “used car purchase.”

### Computing System

In general, the word module, as used herein, refers to logic embodied in hardware or firmware, or to a collection of software instructions, possibly having entry and exit points, written in a programming language, such as, for example, C, C++, or C#. A software module may be compiled and linked into an executable program, installed in a dynamic link library, or may be written in an interpreted programming language such as, for example, BASIC, C++, JavaScript, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In one embodiment, the in the market model module 150 includes, for example, a server or a personal computer that is IBM, Macintosh, or Linux/Unix compatible. In another embodiment, the in the market system 130 comprises a laptop computer, smart phone, personal digital assistant, or other computing device, for example. In one embodiment, the exemplary in the market system 130 includes a central processing unit (“CPU”) 105, which may include one or more conventional or proprietary microprocessors. The in the market system 130 further includes a memory, such as random access memory (“RAM”) for temporary storage of information and a read only memory (“ROM”) for permanent storage of information, and a mass storage device 140, such as a hard drive, diskette, or optical media storage device. In certain embodiments, the mass storage device 140 stores user account data, such as credit data information associated with credit data of respective consumers. Typically, the modules of the in the market system 130 are in communication with one another via a standards based bus system. In different embodiments, the standards based bus system could be Peripheral Component Interconnect (“PCI”), Microchannel, SCSI, Industrial Standard Architecture (“ISA”) and Extended ISA (“EISA”) architectures, for example.

The in the market system 130 is generally controlled and coordinated by operating system and/or server software, such as the Windows 95, 98, NT, 2000, XP, Vista, 7, 8, Linux, SunOS, Solaris, PalmOS, Blackberry OS, or other compatible operating systems. In Macintosh systems, the operating system may be any available operating system, such as MAC OS X. In other embodiments, the in the market model module 150 may be controlled by a proprietary operating system. Conventional operating systems control and schedule computer processes for execution, perform memory management, provide file system, networking, and I/O services, and provide a user interface, such as a graphical user interface (“GUI”), among other things.

The exemplary in the market system 130 may include one or more commonly available input/output (“I/O”) interfaces and devices 210, such as a keyboard, mouse, touchpad, and printer. In one embodiment, the I/O devices and interfaces 170 include one or more display device, such as a monitor, that allows the visual presentation of data to a user. More particularly, a display device provides for the presentation of GUIs, application software data, and multimedia presentations, for example. The in the market system 130 may also include one or more multimedia devices 160, such as speakers, video cards, graphics accelerators, and microphones, for example. In one embodiment, the I/O interfaces and devices 170 comprise devices that are in communication with modules of the in the market system 130 via a network, such as the network 120 and/or any secured local area network, for example.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

What is claimed is:

1. A system for predicting whether a consumer is likely to be in the market for a product or service, the system comprising:
a first physical data store configured to store credit data;
a computing device in communication with the first physical data store and configured to:
receive a request for an in the market assessment associated with at least one consumer;
access credit data from the first physical data store associated with at least one consumer;
apply in the market model to accessed credit data wherein the in the market model uses at least one trended attribute to assign at least one consumer to a trended attribute segment and applies a predictive sub-model to the corresponding trended attribute segment; and
generate an in the market score representative of a likelihood the at least one consumer is in the market for a product or service.

2. The system of claim 1, wherein the credit data includes historical credit data.

3. The system of claim 1, wherein the credit data includes historical credit data and current credit data.

4. The system of claim 1, wherein the at least one consumer includes over 10,000 consumers.

5. The system of claim 1, wherein the product or service is a bank card.

6. The system of claim 1, wherein the product or service is a mortgage.

7. The system of claim 1, wherein the product or service is an automotive loan.

8. A computer-implemented method of predicting whether a consumer is in the market for a product or service, the method comprising:
receiving a request for an in the market assessment associated with a first consumer;
accessing, from an electronic data store, credit data associated with the first consumer;
processing, with one or more hardware computer processors, a in the market model to segment the first consumer into one of a plurality of trended attribute segments, wherein the in the market model analyzes the accessed credit data to assign at least one consumer to a trended attribute segment and applies a predictive sub-model to the corresponding trended attribute segment to generate an in the market score representative of the likelihood the first consumer is in the market for a product or service; and
outputting the in the market score.

9. The computer-implemented method of claim 8, wherein the credit data includes historical credit data.

10. The computer-implemented method of claim 8, wherein the credit data includes historical credit data and current credit data.

11. The computer-implemented method of claim 8, further comprising repeating the computer-implemented method for an additional 10,000 consumers.

12. The computer-implemented method of claim 8, wherein the product or service is a bank card.

13. The computer-implemented method of claim 8, wherein the product or service is a mortgage.

14. The computer-implemented method of claim 8, wherein the product or service is an automotive loan.

15. Non-transitory computer storage having stored thereon a computer program that instructs a computer system by at least:
receiving a request for an in the market assessment associated with a first consumer;
accessing, from an electronic data store, credit data associated with the first consumer;
processing, with one or more hardware computer processors, a in the market model to segment the first consumer into one of a plurality of trended attribute segments, wherein the in the market model analyzes the accessed credit data to assign at least one consumer to a trended attribute segment and applies a predictive sub-model to the corresponding trended attribute segment to generate an in the market score representative of the likelihood the first consumer is in the market for a product or service; and
outputting the in the market score.

16. The non-transitory computer storage of claim 15, wherein the credit data includes historical credit data.

17. The non-transitory computer storage of claim 15, wherein the credit data includes historical credit data and current credit data.

18. The non-transitory computer storage of claim 15, wherein the computer program instructs the computer system to repeat the instructions for an additional 10,000 consumers.

19. The non-transitory computer storage of claim 15, wherein the product or service is a bank card.

20. The non-transitory computer storage of claim 15, wherein the product or service is a mortgage.

21. The non-transitory computer storage of claim 15, wherein the product or service is an automotive loan.

22. A method of assessing whether a consumer is in the market for a good or service, the method comprising:
processing, with one or more hardware computer processors, credit data associated with a first consumer for whom a request for an in the market assessment has been received;
based at least partly on said processing, executing an in the market model and assigning the first consumer to a first trended attribute segment of a plurality of trended attribute segments, and executing a predictive sub-model to the corresponding first trended attribute segment; and
generating, an in the market score representative of the likelihood the first consumer is in the market for a product or service.
